(19) United States
(12) Patent Application Publication
(10) Pub. No.: US 2026/0237284 A1
(43) Pub. Date: Aug. 13, 2026

(54) METHOD FOR MONITORING STABILITY OF HIGH-STEEP SLOPE IN HIGH-ALTITUDE COLD REGION

(71) Applicant: XINJIANG UNIVERSITY, URUMQI CITY (CN)

(72) Inventors: ZIZHAO ZHANG, URUMQI CITY (CN); YANYANG ZHANG, URUMQI CITY (CN); FENGJUN SHAO, URUMQI CITY (CN); JUNPENG HUANG, URUMQI CITY (CN); KAI CHEN, URUMQI CITY (CN); GUANGMING SHI, URUMQI CITY (CN); RUNSEN LAI, URUMQI CITY (CN)

(21) Appl. No.: 19/534,726

(22) Filed: Feb. 9, 2026

(30) Foreign Application Priority Data
Feb. 11, 2025 (CN) 202510149819.2

(51) Int. Cl. G08B 21/18; G01D 21/02; G08B 21/10

(52) U.S. Cl. CPC G08B 21/182; G01D 21/02; G08B 21/10

(57) ABSTRACT

A method for monitoring stability of a high-steep slope in a high-altitude cold region is provided. The method includes the following steps: step 1, geological survey: investigating and analyzing a geological structure, soil and rock types, a rock property, topographic mapping, and a historical disaster record of a slope to be monitored; step 2, terrain measurement: monitoring an elevation, a gradient, an inclination angle, and a crack of the slope to be monitored; step 3, geological environment monitoring: monitoring a temperature, a humidity, a groundwater level, and a rainfall of the slope; step 4, remote sensing monitoring: using a remote sensing (RS) technology to obtain a remote sensing image of the slope and monitor displacement changes within the slope; and step 5, intelligent warning: setting a monitoring threshold based on slope stability, and issuing a warning when monitored data reaches the monitoring threshold.

### CROSS REFERENCE TO RELATED APPLICATION

This patent application claims the benefit and priority of Chinese Patent Application No. 202510149819.2, filed with the China National Intellectual Property Administration on February 11, 2025, the disclosure of which is incorporated by reference herein in its entirety as part of the present application.

### TECHNICAL FIELD

The present disclosure relates to the field of high-altitude mining technologies, and in particular, relates to a method for monitoring stability of a high-steep slope in a high-altitude cold region.

### BACKGROUND

High-altitude cold regions typically refer to areas with high altitudes (for example, the Kunlun Mountains) characterized by cold and variable climates. Slopes in these regions face extreme natural conditions, and rock and soil masses are significantly affected by a freeze-thaw action, making the slopes highly susceptible to geological hazards including collapses, landslides, and the like. These regions are often geologically active, prone to the development of weak interlayers, faults, joints, and other structural features, increasing a risk of slope instability. Consequently, monitoring slope stability in such regions is a complex engineering challenge, particularly for slopes located within mining areas.

In the conventional technology, slope stability monitoring is often limited to single‑dimensional data collection, and therefore, it is difficult to comprehensively and accurately reflect an overall safety condition of a slope. Due to a limited monitoring scope, only parameter changes in localized areas of the slope can be captured, making it impossible to fully grasp a dynamic evolution process of the entire slope.

In summary, how to resolve the problem of an existing single‑dimensional data collection method failing to fully reflect the overall safety condition of the slope has become a problem that needs to be urgently resolved in the field. Therefore, it is necessary to propose a method for monitoring stability of a high-steep slope in a high-altitude cold region.

### SUMMARY

To resolve the foregoing problem, the present disclosure provides a method for monitoring stability of a high-steep slope in a high-altitude cold region. Slope stability is comprehensively assessed in a plurality of dimensions including geological survey, terrain measurement, geological environment monitoring, remote‑sensing monitoring, and the like, and prioritized monitoring of a historically hazardous region is implemented, thereby ensuring comprehensiveness of the monitoring and accuracy of data.

To achieve the objective, the present disclosure adopts the following technical solution. A method for monitoring stability of a high-steep slope in a high-altitude cold region includes the following steps:

step 1, geological survey: investigating and analyzing a geological structure, soil and rock types, a rock property, topographic mapping, and a historical disaster record of a slope to be monitored;

step 2, terrain measurement: disposing a plurality of parameter acquisition apparatuses on a slope to be monitored, and using the plurality of parameter acquisition apparatuses to monitor an elevation, a gradient, an inclination angle, and a crack of the slope to be monitored; and analyzing a horizontal offset, a vertical displacement, and a tilt offset of the slope to be monitored;

step 3, geological environment monitoring: using the plurality of parameter acquisition apparatuses to monitor a temperature, a humidity, a groundwater level, and a rainfall of the slope to be monitored;

step 4, remote sensing monitoring: using a remote sensing (RS) technology to obtain a remote sensing image of the slope and monitor displacement changes within the slope; and

step 5, intelligent warning: setting a monitoring threshold based on slope stability, and issuing a warning when monitored data reaches the monitoring threshold.

Further, in step 2, the plurality of parameter acquisition apparatuses are arranged in a linear array on the slope to be monitored to obtain initial horizontal position information of each monitoring point; and during monitoring, the horizontal offset of the slope to be monitored is analyzed by comparing a horizontal position obtained in subsequent monitoring with the initial horizontal position information.

Further, in step 2, after the plurality of parameter acquisition apparatuses are mounted, an initial elevation of each monitoring point is obtained, and the vertical displacement of the slope to be monitored is analyzed by comparing and analyzing a difference between an elevation in subsequent monitoring and the initial elevation.

Further, in step 2, the tilt offset of the slope to be monitored is analyzed by determining an offset angle between adjacent parameter acquisition apparatuses based on inclination angle signals acquired by the adjacent parameter acquisition apparatuses.

Further, in step 3, temperature changes of the slope to be monitored are obtained through the plurality of parameter acquisition apparatuses, and impact of a freeze-thaw action on the slope to be monitored is analyzed based on the temperature changes.

With the adoption of the technical solution, the present disclosure has the following beneficial effects.

1. Slope stability is comprehensively assessed in a plurality of dimensions including geological survey, terrain measurement, geological environment monitoring, remote‑sensing monitoring, and the like, and historical data is investigated and analyzed to evaluate past slope disasters in the region, thereby identifying areas at potential risk of future slope instability. These high-risk areas are then prioritized for monitoring, thereby ensuring comprehensiveness of the monitoring and accuracy of data. Fundamental geological information about the slope is provided through geological survey. Slope deformation is directly monitored through terrain measurement. Impact of external environmental factors on slope stability is considered in geological environment monitoring; Regional-scale change trends are captured from a macroscopic perspective in remote-sensing monitoring.

Specifically designed for the extreme conditions of high-steep slope in a high-altitude cold region, the method addresses factors including a low temperature, a freeze-thaw cycle, a tectonic fracture, slope deformation, and the like, making the monitoring method more practical and closely aligned with actual field conditions. Analyses of the horizontal offset, the vertical displacement, and the tilt offset can be combined to provide more accurate data support, facilitating early detection of potential risks.

2. The parameter acquisition apparatuses are used in the present disclosure to collect various data of the slope to be monitored in real time. The monitoring threshold is predefined, and once the data reaches or exceeds the monitoring threshold, a warning is issued immediately. This real-time monitoring and early-warning mechanism enables timely detection of potential slope stability problems, allowing valuable time for emergency responses and effectively reducing occurrence of disasters.

The method is not only applicable to current slope stability monitoring but also provides a scientific basis for slope management and long-term maintenance through continuous data collection and analysis. In addition, the method is replicable and can be extended to monitor slope stability in other areas with similar geological environments.

3. Modern technological means including the RS technology, the intelligent warning system, and the like are combined in the present disclosure, enhancing scientific rigor and intelligence of monitoring. Image information can be quickly captured from the slope by using the remote sensing technology, providing visual evidence for analyzing slope changes. The intelligent warning system can be configured to automatically assess conditions based on preset criteria and issues alerts, reducing reliance on manual intervention and minimizing the likelihood of misjudgment.

4. The parameter acquisition apparatuses are arranged in a linear array, the horizontal offset, the vertical displacement, and the tilt offset of the slope to be monitored can be monitored more precisely, thereby improving monitoring accuracy.

Further, each of the parameter acquisition apparatuses includes a controller and a hollow fixed base, a rotating ring is rotatably fitted to an outer side of the fixed base, and a bottom of the fixed base is fixedly connected with a plurality of support legs; and blades are fixedly connected in a circumferential direction of the rotating ring.

An inclinometer and a global positioning system (GPS) locator are disposed in the fixed base, and the bottom of the fixed base is fixedly connected with an acoustic sensor; the bottom of the fixed base is further fixedly connected with an extension rod, and a water level gauge is fixedly connected to the extension rod; a temperature and humidity sensor is also mounted on the rotating ring; and the inclinometer, the GPS locator, the acoustic sensor, the water level gauge, and the temperature and humidity sensor are all electrically connected to the controller.

A conversion assembly for converting wind energy into electrical energy is disposed inside the fixed base.

Beneficial Effects: Wind energy is converted by the conversion assembly into electrical power for supplying power to the apparatus. The rotating ring is rotatably fitted to the outer side of the fixed base and the blades are fixed in the circumferential direction of the rotating ring. The blades can be rotated through effect of wind force, thereby driving the rotating ring to rotate correspondingly. Additionally, the temperature and humidity sensor is mounted on the rotating ring. When the rotating ring rotates, temperature and humidity information from different directions at the monitoring point can be acquired, resulting in more accurate monitoring data. An inclination condition of the monitoring point can be obtained by the built‑in inclinometer, and a position and an elevation at the monitoring point can be monitored by the GPS locator. Crack propagation inside the rock or soil mass can be acquired by the acoustic sensor, indirectly reflecting changes in the internal structure of the slope to be monitored . Variations in the groundwater level can be directly monitored by the water level gauge. Through this integrated multi‑parameter monitoring approach, more comprehensive data support is provided, facilitating in‑depth analysis of impact of the freeze‑thaw cycle on a state of the slope to be monitored.

Further, the conversion assembly includes an internal gear ring, a central gear, and a plurality of transmission gears. The internal gear ring is fixedly connected to a top of the rotating ring. The transmission gears are all located within sidewalls of the fixed base and are rotatably fitted to the sidewalls of the fixed base. The central gear is located inside a hollow interior of the fixed base. The internal gear ring, the central gear, and the rotating ring are concentrically. The transmission gears are meshed with both the internal gear ring and the central gear.

An inner sidewall of the fixed base is fixedly connected with a power component for power generation. The central gear is coaxially fixedly connected to a rotating shaft of the power component. The power component is electrically connected to an energy storage component for storing power, and the energy storage component is fixedly connected to an inner bottom wall of the fixed base.

Beneficial Effects: The rotating ring is rotated under effect of wind force. The internal gear ring is fixedly connected to the top of the rotating ring and is meshed with the transmission gears, and the transmission gears are meshed with the central gear. The rotating ring is rotated to drive the internal gear ring, which in turn drives the transmission gears to rotate. Through an action of the transmission gears, a rotational speed of the central gear is further increased. As the central gear is coaxially and fixedly connected to the rotating shaft of the power component, and the power component is electrically connected to the energy storage component, mechanical energy is converted into electrical energy through rotation of the power component. The electrical energy is stored by the energy storage component, and is supplied to various circuit elements of the apparatus, meeting needs for unmanned monitoring in remote areas.

Further, solar panels are fixedly connected to outer walls of the blades, and the solar panels are all electrically connected to the energy storage component.

Beneficial Effects: The solar panels can be designed to further improve energy recovery efficiency. The solar panels operate in complement with wind energy, further improving overall energy recovery efficiency of the apparatus.

Further, a heating member for providing thermal energy is further fixedly connected to an outer wall of the fixed base, and the controller is configured to control operation of the heating member.

Beneficial effects: For the high-altitude regions, the heating member is additionally designed, making the apparatus operate in a low-temperature environment, thereby ensuring reliable operation of the apparatus.

Further, a sliding block is fixedly connected to an inner sidewall of the rotating ring, and a sliding groove for movement of the sliding block is provided on the outer wall of the fixed base.

Beneficial Effects: The sliding block is fitted to the sliding groove, to provide a guidance function, enabling the rotating ring to smoothly rotate around the fixed base. This effectively reduces a potential offset or jamming during rotation, and enhances operational stability of the apparatus.

Additional aspects and advantages of the present disclosure will be partly provided in the following description, and partly become evident in the following description or understood through the practice of the present disclosure.

### BRIEF DESCRIPTION OF THE DRAWINGS

FIG. 1 is a schematic diagram of a method for monitoring stability of a high-steep slope in a high-altitude cold region according to the present disclosure;

FIG. 2 is an axonometric view of a parameter acquisition apparatus in a method for monitoring stability of a high-steep slope in a high-altitude cold region according to the present disclosure;

FIG. 3 is a sectional view of a parameter acquisition apparatus in a method for monitoring stability of a high-steep slope in a high-altitude cold region according to the present disclosure; and

FIG. 4 is an axonometric view of a conversion assembly in a method for monitoring stability of a high-steep slope in a high-altitude cold region according to the present disclosure.

Reference numerals in the accompanying drawings of the specification: 1, fixed base; 2, rotating ring; 3, blade; 4, internal gear ring; 5, central gear; 6, transmission gear; 7, power generator; 8, storage battery; 9, heating plate; 10, sliding block; and 11, support leg.

### DETAILED DESCRIPTION OF THE EMBODIMENTS

The present disclosure is described in more detail below with reference to the specific implementations.

### Embodiment 1

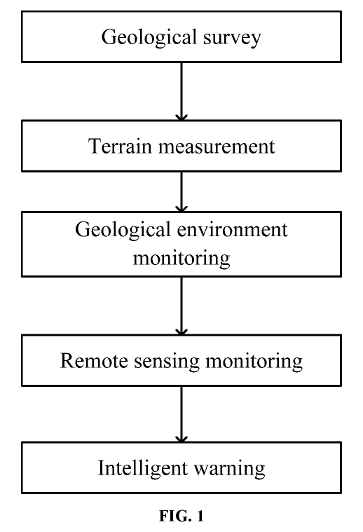

As shown in FIG. 1, a method for monitoring stability of a high-steep slope in a high-altitude cold region includes the following steps.

In step 1, geological survey is performed: A geological structure, soil and rock types, a rock property, topographic mapping, and a historical disaster record of a slope are investigated and analyzed. A topographic mapping technology is combined to describe a geometric configuration of a slope, and historical disaster records are systematized to analyze rules and causes of past hazards, providing a geological basis for subsequent monitoring.

In step 2, terrain measurement is performed: A plurality of parameter acquisition apparatuses are disposed on a slope to be monitored, and the plurality of parameter acquisition apparatuses are used to monitor an elevation (via the GPS locator), a gradient, an inclination angle (via the inclinometer), and a crack (via the acoustic sensor) of a slope to be monitored; and a horizontal offset, a vertical displacement, and a tilt offset of the slope to be monitored are analyzed.

Specifically, the plurality of parameter acquisition apparatuses are arranged in a linear array on the slope to be monitored (or form a special grid form) to obtain initial horizontal position information of each monitoring point. During monitoring, the horizontal offset of the slope to be monitored is analyzed by comparing a horizontal position obtained in subsequent monitoring with the initial horizontal position information. Areas with severe local deformation can be further identified, thus providing a basis for targeted remediation measures.

After the plurality of parameter acquisition apparatuses are mounted, an initial elevation of each monitoring point is obtained, and the vertical displacement of the slope to be monitored is analyzed by comparing and analyzing a difference between an elevation in subsequent monitoring and the initial elevation. For example, a differential GPS technology is adopted to effectively improve accuracy of elevation measurement, thereby enhancing reliability of vertical displacement monitoring.

The tilt offset of the slope to be monitored is analyzed by determining an offset angle between adjacent parameter acquisition apparatuses based on inclination angle signals acquired by the adjacent parameter acquisition apparatuses. A spatial geometric principle can be used to precisely calculate a relative offset angle between adjacent monitoring points, enabling assessment of overall wobble stability of the slope to be monitored and providing valuable data for research on dynamic response characteristics of the slope to be monitored.

In step 3, geological environment monitoring is performed: The plurality of parameter acquisition apparatuses are configured to monitor a temperature, a humidity, a groundwater level, and a rainfall of the slope to be monitored. Particularly in high-altitude cold regions, frequent extreme weather events (for example, blizzards and freeze-thaw cycles) can significantly exacerbate the state of the slope to be monitored. Therefore, by monitoring environmental parameters around the slope to be monitored , special attention is given to weather-related variables including a groundwater level and a rainfall. Emphasis is placed on analyzing the impact of temperature-induced freeze-thaw cycle on slope stability, to help identify potential risk areas.

In step 4, remote sensing monitoring is performed: A remote sensing (RS) technology is used to obtain a remote sensing image of the slope and monitor displacement changes within the slope. This can not only allow for direct observation of macroscopic changes within the slope (for example, variations in vegetation coverage and exposed surface area), but also enables extraction of subtle surface deformation features through an image‑processing technology.

For example, an InSAR technology is used to achieve millimeter‑scale ground settlement monitoring, and a high‑resolution three‑dimensional terrain model is provided by a LiDAR, thereby helping detecting early signs of landslides. In addition, aerial photography using an unmanned aerial vehicle is used as a flexible and rapid supplementary manner, providing immediate feedback under a specific circumstance, especially in an emergency event.

In step 5, intelligent warning is performed: A monitoring threshold is set based on slope stability, and a warning is issued when monitored data reaches the monitoring threshold. An alarm is immediately triggered by the warning. Sending alert notifications to relevant personnel via SMS, email, automated calls, or other means can ensure a rapid response and necessary disaster prevention and mitigation measures.

A specific implementation process is as follows: Slope stability is comprehensively assessed in a plurality of dimensions including geological survey, terrain measurement, geological environment monitoring, remote‑sensing monitoring, and the like, and historical data is investigated and analyzed to evaluate past slope disasters in the region, thereby identifying areas at potential risk of future slope instability. These high-risk areas are then prioritized for monitoring, and the monitoring points are disposed in the areas, thereby ensuring comprehensiveness of the monitoring and accuracy of data. Fundamental geological information about the slope is provided through geological survey. Slope deformation is directly monitored through terrain measurement. Impact of external environmental factors on slope stability is considered in geological environment monitoring; Regional-scale change trends are captured from a macroscopic perspective in remote-sensing monitoring.

Specifically designed for the extreme conditions of high-steep slope in a high-altitude cold region, the method addresses factors including a low temperature, a freeze-thaw cycle, a tectonic fracture, and the like, making the monitoring method more practical and closely aligned with actual field conditions. Analyses of the horizontal offset, the vertical displacement, and the tilt offset can be combined to provide more accurate data support, facilitating early detection of potential risks.

### Embodiment 2

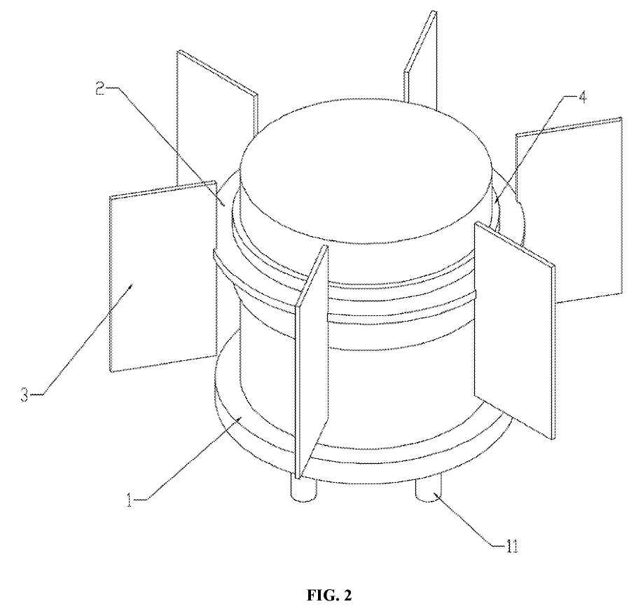

As shown in FIG. 2 to FIG. 4, a difference from the above-described embodiment lies in that, each of the parameter acquisition apparatuses includes a controller and a hollow fixed base 1. A rotating ring 2 is rotatably fitted to an outer side of the fixed base 1, and a bottom of the fixed base 1 is fixedly connected with a plurality of support legs 11 via bolts. Blades 3 are fixedly connected in a circumferential direction of the rotating ring 2.

An inclinometer and a global positioning system (GPS) locator are disposed in the fixed base 1. The bottom of the fixed base 1 is fixedly connected with an acoustic sensor via bolt. The bottom of the fixed base 1 is further fixedly connected with an extension rod. A water level gauge is fixedly connected to the extension rod. In this embodiment, the extension rod is an adjustable-length telescopic rod. The extension rod is mounted in a stratum by drilling, enabling monitoring of water levels at different depths in the stratum. A temperature and humidity sensor is also mounted on the rotating ring 2. The inclinometer, the GPS locator, the acoustic sensor, the water level gauge, and the temperature and humidity sensor are all electrically connected to the controller.

A conversion assembly for converting wind energy into electrical energy is disposed inside the fixed base 1.

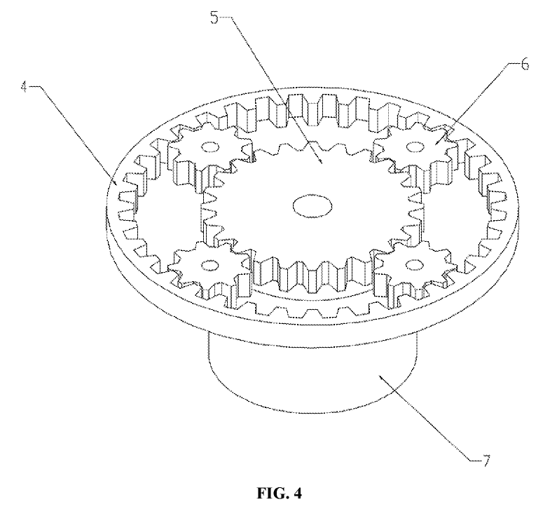

As shown in FIG. 4, the conversion assembly includes an internal gear ring 4, a central gear 5, and a plurality of transmission gears 6. The internal gear ring 4 is fixedly connected to a top of the rotating ring 2 via a bolt. The transmission gears 6 are all located within sidewalls of the fixed base 1 and are rotatably fitted to the sidewalls of the fixed base 1. The central gear 5 is located inside a hollow interior of the fixed base 1. The internal gear ring 4, the central gear 5, and the rotating ring 2 are concentrically. The transmission gears 6 are meshed with both the internal gear ring 4 and the central gear 5.

The inner sidewall of the fixed base 1 is fixedly connected to a power component via a bolt for power generation. In this embodiment, the power component is a power generator 7. The principle of the power generator 7 is based on the conventional technology and is not described in detail herein. The central gear 5 is coaxially fixedly connected to a rotating shaft of the power generator 7. The power generator 7 is electrically connected to an energy storage component for storing power. The energy storage component in this embodiment is a storage battery 8, and the storage battery 8 is fixedly connected to an inner bottom wall of the fixed base 1 via a bolt.

A specific implementation process is as follows: First, the support legs 11 can be fastened, via bolts, to the slope to be monitored, to enhance stability of mounting. The rotating ring 2 is rotated under effect of wind force. The internal gear ring 4 is fixedly connected to the top of the rotating ring 2 via a bolt, the internal gear ring 4 is meshed with the transmission gears 6, and the transmission gears 6 are meshed with the central gear 5. When the rotating ring 2 is rotated under effect of wind force, the internal gear ring 4 on the top is driven to rotate, and the internal gear ring 4 drives the transmission gears 6 to rotate. Through an action of the transmission gears 6, a rotational speed of the central gear 5 is further increased.

As the central gear 5 is coaxially and fixedly connected to the rotating shaft of the power generator 7 via a bolt, and the power generator 7 is electrically connected to the storage battery 8. The rotating shaft of the power generator 7 is driven by the central gear 5 to rotate, and mechanical energy is converted by the power generator 7 into electrical energy. The storage battery 8 is configured to store the electrical energy. The stored electrical energy is used to supply power to various circuit elements of the apparatus, meeting needs for unmanned monitoring in remote areas. In this embodiment, the storage battery 8 serves only as a backup power source. When the storage battery 8 is nearly used up, the storage battery 8 is replaced by personnel. Alternatively, a quantity of storage batteries 8 may be increased to meet power supply of the apparatus.

Wind energy is converted into electrical power for supplying power to the apparatus. The rotating ring 2 is rotatably fitted to the outer side of the fixed base 1 and the blades 3 are fixed in the circumferential direction of the rotating ring 2. The blades 3 can be rotated through effect of wind force. The blades 3 are rotated to drive the rotating ring 2 to rotate correspondingly. In addition, the temperature and humidity sensor is mounted on the rotating ring 2. When the rotating ring 2 rotates, temperature and humidity information from different directions at the monitoring point can be acquired, resulting in more accurate monitoring data, and improving comprehensiveness of data.

An inclination condition of the monitoring point can be obtained by the built‑in inclinometer, to obtain an angle deviation between two adjacent apparatuses. A position and an elevation at the monitoring point can be monitored by the GPS locator, to analyze changes in both the horizontal offset and vertical displacement of the slope to be monitored. Propagation of internal fractures within the rock or soil mass, as well as other abnormal acoustic signals can be acquired by the acoustic sensor, thereby indirectly reflecting changes in the internal structure of the slope to be monitored . This is particularly effective for detecting deep-seated cracks. Changes in the groundwater level are directly monitored by the water level gauge, especially in high‑cold regions where freeze‑thaw cycles occur frequently. Through such an integrated multi‑parameter monitoring manner, more comprehensive data support is provided, facilitating in‑depth analysis of various impacts of the freeze‑thaw cycle on the state of the slope to be monitored, which contributes to the understanding of the slope stability.

### Embodiment 3

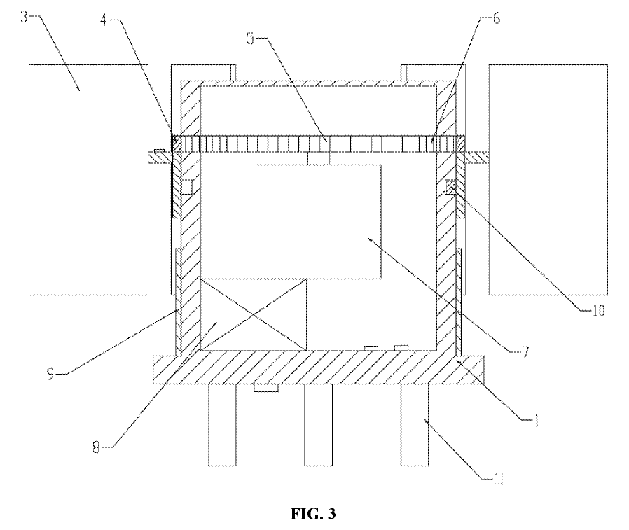

As shown in FIG. 2 and FIG. 3, a difference from the above embodiment lies in that, solar panels are fixedly connected to outer walls of the blades 3 via bolts, and the solar panels are electrically connected to the storage battery 8.

A specific implementation process is as follows: In consideration of the characteristics of high‑altitude regions, electrical resources may be relatively scarce but natural resources are relatively abundant. The solar panels can be designed to further improve energy recovery efficiency. The solar panels operate in complement with wind energy, further improving overall energy recovery efficiency of the apparatus.

### Embodiment 4

As shown in FIG. 3, a difference from the above embodiment lies in that, a heating member for providing thermal energy is further fixedly connected to the outer wall of the fixed base 1 via a bolt. In this embodiment, the heating member is a heating plate 9. The fixed base 1 is made of a material with excellent thermal insulation properties. The controller is configured to control operation of the heating plate 9.

A specific implementation process is as follows: For the high-altitude regions, the heating plate 9 is additionally designed, making the apparatus operate in a low-temperature environment, thereby ensuring reliable operation of the apparatus.

### Embodiment 5

As shown in FIG. 3, a difference from the above embodiment lies in that, a sliding block 10 is fixedly connected to an inner sidewall of the rotating ring 2 via a bolt, and a sliding groove for movement of the sliding block 10 is provided on the outer wall of the fixed base 1.

A specific implementation process is as follows: The sliding block 10 is fitted to the sliding groove, to provide a guidance function, enabling the rotating ring 2 to smoothly rotate around the fixed base 1. This effectively reduces a potential offset or jamming during rotation, and enhances operational stability of the apparatus.

It is apparent that the above embodiments are merely listed for clear description, and are not intended to limit the implementations. The person of ordinary skill in the art may make modifications or variations in other forms based on the above description. There are no need and no way to exhaust all of the implementations. Obvious changes or variations made thereto shall still fall within the protection scope of the present disclosure.

What is claimed is:

1. A method for monitoring stability of a high-steep slope in a high-altitude cold region, comprising following steps:
step 1, geological survey, comprising investigating and analyzing a geological structure, soil and rock types, a rock property, topographic mapping, and a historical disaster record of a slope to be monitored;
step 2, terrain measurement, comprising disposing a plurality of parameter acquisition apparatuses on the slope to be monitored, and using the plurality of parameter acquisition apparatuses to monitor an elevation, a gradient, an inclination angle, and a crack of the slope to be monitored; and analyzing a horizontal offset, a vertical displacement, and a tilt offset of the slope to be monitored;
step 3, geological environment monitoring, comprising using the plurality of parameter acquisition apparatuses to monitor a temperature, a humidity, a groundwater level, and a rainfall of the slope to be monitored;
step 4, remote sensing monitoring, comprising using a remote sensing (RS) technology to obtain a remote sensing image of the slope to be monitored and monitor displacement changes within the slope to be monitored; and
step 5, intelligent warning, comprising setting a monitoring threshold based on slope stability, and issuing a warning when monitored data reaches the monitoring threshold.

2. The method for monitoring stability of a high-steep slope in a high-altitude cold region according to claim 1, wherein in step 2, the plurality of parameter acquisition apparatuses are arranged in a linear array on the slope to be monitored to obtain initial horizontal position information of each monitoring point; and during monitoring, the horizontal offset of the slope to be monitored is analyzed by comparing a horizontal position obtained in subsequent monitoring with the initial horizontal position information.

3. The method for monitoring stability of a high-steep slope in a high-altitude cold region according to claim 2, wherein in step 2, after the plurality of parameter acquisition apparatuses are mounted, an initial elevation of each monitoring point is obtained, and the vertical displacement of the slope to be monitored is analyzed by comparing and analyzing a difference between an elevation in subsequent monitoring and the initial elevation.

4. The method for monitoring stability of a high-steep slope in a high-altitude cold region according to claim 3, wherein in step 2, the tilt offset of the slope to be monitored is analyzed by determining an offset angle between adjacent ones of the plurality of parameter acquisition apparatuses based on inclination angle signals acquired by the adjacent ones of the plurality of parameter acquisition apparatuses.

5. The method for monitoring stability of a high-steep slope in a high-altitude cold region according to claim 4, wherein in step 3, temperature changes of the slope to be monitored are obtained through the plurality of parameter acquisition apparatuses, and impact of a freeze-thaw action on the slope to be monitored is analyzed based on the temperature changes.

6. The method for monitoring stability of a high-steep slope in a high-altitude cold region according to claim 5, wherein each of the parameter acquisition apparatuses comprises a controller and a hollow fixed base (1), a rotating ring (2) is rotatably fitted to an outer side of the fixed base (1), and a bottom of the fixed base (1) is fixedly connected with a plurality of support legs (11); and blades (3) are fixedly connected in a circumferential direction of the rotating ring (2);
an inclinometer and a global positioning system (GPS) locator are disposed in the fixed base (1), and the bottom of the fixed base (1) is fixedly connected with an acoustic sensor; the bottom of the fixed base (1) is further fixedly connected with an extension rod, and a water level gauge is fixedly connected to the extension rod; a temperature and humidity sensor is also mounted on the rotating ring (2); and the inclinometer, the GPS locator, the acoustic sensor, the water level gauge, and the temperature and humidity sensor are all electrically connected to the controller; and
a conversion assembly for converting wind energy into electrical energy is disposed inside the fixed base (1).

7. The method for monitoring stability of a high-steep slope in a high-altitude cold region according to claim 6, wherein the conversion assembly comprises an internal gear ring (4), a central gear (5), and a plurality of transmission gears (6), and the internal gear ring (4) is fixedly connected to a top of the rotating ring (2); the transmission gears (6) are all located within sidewalls of the fixed base (1) and are rotatably fitted to the sidewalls of the fixed base (1); the central gear (5) is located inside a hollow interior of the fixed base (1); the internal gear ring (4), the central gear (5), and the rotating ring (2) are concentrically; and the transmission gears (6) are meshed with both the internal gear ring (4) and the central gear (5); and
an inner sidewall of the fixed base (1) is fixedly connected with a power component for power generation; the central gear (5) is coaxially fixedly connected to a rotating shaft of the power component; and the power component is electrically connected to an energy storage component for storing power, and the energy storage component is fixedly connected to an inner bottom wall of the fixed base (1).

8. The method for monitoring stability of a high-steep slope in a high-altitude cold region according to claim 7, wherein solar panels are fixedly connected to outer walls of the blades (3), and the solar panels are all electrically connected to the energy storage component.

9. The method for monitoring stability of a high-steep slope in a high-altitude cold region according to claim 8, wherein a heating member for providing thermal energy is further fixedly connected to an outer wall of the fixed base (1), and the controller is configured to control operation of the heating member.

10. The method for monitoring stability of a high-steep slope in a high-altitude cold region according to claim 9, wherein a sliding block (10) is fixedly connected to an inner sidewall of the rotating ring (2), and a sliding groove for movement of the sliding block (10) is provided on the outer wall of the fixed base (1).
